(19) United States
(12) Patent Application Publication
(10) Pub. No.: US 2005/0067882 A1
(43) Pub. Date: Mar. 31, 2005

(54) Wheel, in particular a spoked wheel for motor vehicles constructed from sheet-steel

(76) Inventors: Klaus Bluemel, Dinslaken (DE); Jens Stach, Heimsheim (DE)

Correspondence Address: PROSKAUER ROSE LLP;PATENT DEPARTMENT, 1585 BROADWAY, NEW YORK, NY, 10036-8299, US

(21) Appl. No.: 10/479,694

(22) PCT Filed: Jun. 5, 2002
(86) PCT No.: PCT/EP02/06121

(30) Foreign Application Priority Data
Jun. 7, 2001 (DE) 101 27 639.7

(51) Int. Cl. B60B 3/10

(52) U.S. Cl. 301/64.101

(57) ABSTRACT

The invention relates to a wheel rim, in particular a spoked wheel rim for motor vehicles consisting of sheet-steel. Said rim is assembled from various parts: an inner screw-on flange (1b), a central rim ring (1a) and an external rim well (3, 4, 5). The rim ring (1a) and the screw-on flange (1b) form an inner bearing shell (1) for the main bearing load of the wheel rim. Said bearing shell (1) is covered by an external design shell (2) consisting of sheet-steel, forming a hollow chamber (7). Said design shell is connected in a fixed manner to the screw-on flange (1b) and the rim flange (3) and is configured to support an auxiliary bearing load.

The invention relates to a wheel made in several parts for motor vehicles, in particular passenger vehicles or motorcycles. Known wheels of this type made of steel consist as a rule of a one-piece rim ring and a design shell via which the wheel is attached to a hub of the motor vehicle in question.

As a rule the wheel is attached by means of several screw bolts. For this purpose a screw-down flange in which several screw-down openings, preferably provided with a conical seat is formed on the known wheels, normally on the design shell. The screw bolts are inserted through these openings and are screwed into the corresponding threaded bores of the hub or of the brake located on the hub.

The design shell and the rim ring which is produced separately from it are normally welded together. For this purposes latches on which the welding is performed are bent towards the outside and are formed on the outer edge of the design shell and are pressing against the inside surface of the rim ring.

Wheels of the type described above can be produced inexpensively and are therefore part of the standard equipment of most motor vehicles. In many instances however, they do not meet the growing requirements of buyers regarding the outer appearance of the vehicle. In order to improve the appearance, a circle of holes can be made in the design shell, but such a design element cannot compete with spokes that have not been realized so far with sheet steel wheel rims.

In order to improve the appearance of wheel rims made in sheet-metal construction, it has been known to cover them with ornamental screens. Aside from the fact that such ornamental screens can easily be recognized as such, the screens are generally difficult to center precisely, and this is a further visual disadvantage. Finally they cover in many cases the air admission opening in the wheel rims that are necessary to cool the brake, so that brake cooling is affected.

Such disadvantages do not occur in cast or forged rims made of light metal which can easily be made in form of spoked-wheel rims for design purposes. Cast light metal rims must however be finished mechanically and must be balanced for a quiet running of the wheel. In addition cast light metal rims are not suited for heavy wheel loads. With cast wheels with hollow spokes corrosion that cannot be controlled may furthermore occur in the hollow spaces of the spokes and cause weakening of the wheel.

Because of the higher production costs and the limited load-bearing capacity of cast light metal rims, forged rims are preferred where more demanding requirements must be met, but they require the utilization of more expensive light metal kneaded alloys. In addition it is difficult to protect light metal rims from corrosion by aggressive media such as e.g. salt strewn out in the winter.

It is the object of the invention to create a wheel for motor vehicles that is light in weight and can be produced economically while retaining greatest possible configuration freedom for design purposes.

This object is attained by a wheel for motor vehicles, in particular passenger vehicles or motorcycles made in several parts, having a rim ring and equipped with a design shell located in the opening surrounded by the rim ring that can be attached to a wheel hub of the motor vehicle and by a covering shell located on the outside of the wheel, whereby the design shell and the covering shell bear the rim ring jointly.

If the vehicle is a passenger car or a truck, the covering shell is advantageously positioned on the outside of the wheel that points away from the body of the motor vehicle following assembly. On wheels of motorcycles a suitable covering shell can be attached in an inventive manner on at least one of the outsides visible after assembly. For motorcycles it is of course also possible to provide outer shells on both visible sides in an inventive manner.

By contrast with other ornamental screens used with steel rims, the covering shell does not only have the function of a simple design element but at the same time bears part of the forces bearing on the rim ring during operation. The division of the forces absorbed by these two components, design shell and covering shell, can in this case be adapted to the configuration of the wheel. It is however essential that the covering shell bear always a significant share, preferably up to 50%, of the forces acting upon the wheel during operation.

With a design of a wheel according to the invention, great freedom is given on the one hand for the design of the wheel's outer appearance. On the other hand, due to the fact that the covering shell also bears part of the load for which the overall wheel must be designed, the thickness of the material used for the design shell can be reduced.

As a result the invention thus provides a wheel that distinguishes itself by a freely configurable appearance and reduced overall weight. At the same time the wheel according to the invention can be produced very economically due to the possibility of using prefabricated parts. A wheel according to the invention thus combines the advantages of visual appearance and of weight of light metal wheels with the cost advantages that can be achieved in the manufacture of conventional steel wheels.

Depending on the design of the wheel in every case, and on the loads occurring in operation, the covering shell and the rim ring can be connected to each other positively, non-positively and/or material-interlockingly. In case of a material-interlocking connection it is possible to weld the parts that are in contact together if suitable materials are used for the production of the individual wheel parts. Plasma welding is especially well suited for this purpose. Alternatively, the covering shell can also be bonded or soldered to the rim ring insofar as the design, the loads occurring in operation and the materials of the elements to be connected to each other permit this.

On the design shell, screw-down openings through which it is attached to the hub of the motor vehicle should be provided in a known manner on the design shell. These screw-down openings are preferably formed in a screw-down flange of the design shell. Such a screw-down flange which is made as a rule in one piece with the design shell can be formed in such manner as to provide an optimal contact surface for the attachment on the hub of the vehicle and at the same time enhances the rigidity of the wheel through its configuration.

An especially preferred embodiment of the invention is in addition characterized in that the covering shell and the design shell can together be screwed to the corresponding hub of the motor vehicle by means of at least one screw connection. In this embodiment of the invention the design shell as well as the covering shell is connected directly to the vehicle by means of the screw bolts used to attach the wheel. All the forces they absorb are directed in this manner directly into the corresponding screw bolt, so that the forces born by the rim ring are divided optimally between the design shell and the covering shell.

Alternatively or in addition to a joint attachment, the covering shell can also be connected firmly to the design shell in the area of the screw-down openings. For this the covering shell can be welded, bonded or soldered to the design shell. The covering shell can be connected firmly yet detachable as well by a separate screw connection to the design shell.

Another embodiment of the invention that is important in practice is characterized in that the design shell is provided with at least one spoke via which the rim ring is connected to the screw-down flange. From the point of view of weight optimization it is in that case advantageous if the design shell and the covering shell are distanced from each other at least in sections, so that a space is created between them. This can be achieved e.g. if the design shell has the form of an U profile in the area of its spokes, the open side of the U profile being covered by the corresponding spokes of the covering shell. In this manner it is possible to attain great rigidity of the overall construction, so that a wheel according to the invention can also be made as a spoked wheel.

Wheels according to the invention can be produced very economically if steel is used for their manufacture. This steel can be conventional carbon-containing steel used for that purpose. Especially good characteristics in use together with optimized appearance can be achieved however if the rim ring, the design shell and/or the covering shell are made of special steel. It is of course also possible to combine parts that are made of different steel materials or other materials such as carbon with each other.

The rim well can be joined together from sheets of different firmness and/or thickness while taking into account the required loads in the different areas.

In the inside of the covering shell, away from the design shell, a ring element can be provided which holds the wheel at a distance from the corresponding hub of the motor vehicle in its assembled state on the motor vehicle. This ring element assumes in that case the function of a simple washer through which the long wheel base of the vehicle is increased. In addition, the ring element can be used as a barrier to prevent excessive heating up of the covering shell and of the design shell. It is also possible to attenuate the transmission of oscillations from the wheel to the vehicle's running gear by means of the ring element.

Additional advantageous embodiments of the invention are indicated in the dependant claims and are explained in further detail together with the examples of embodiments described below through a drawing.

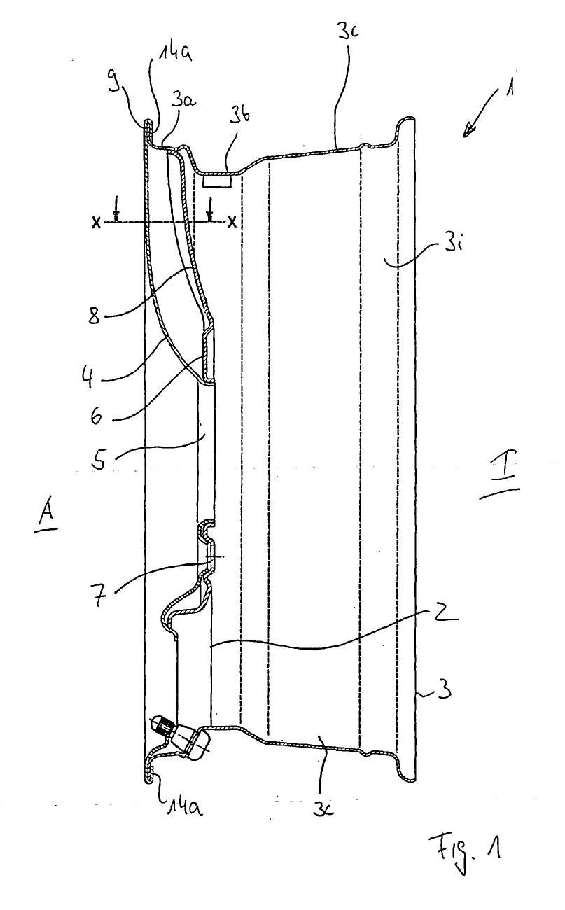

FIG. 1 shows a wheel of a passenger car, in a longitudinal section;

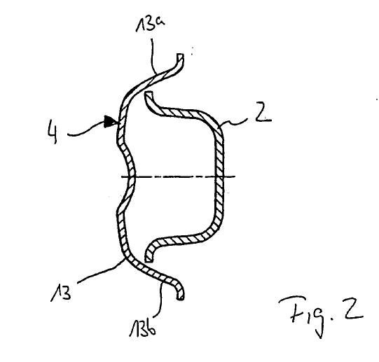

FIG. 2 shows the wheel of FIG. 1 in a section along the line X-X drawn in FIG. 1;

FIG. 3 shows the outside of the wheel represented in FIG. 1 which is visible when it is mounted on the vehicle;

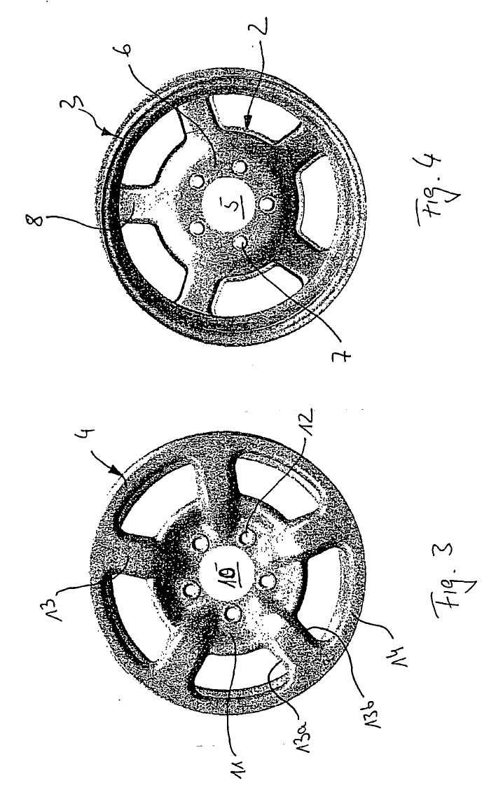

FIG. 4 the inside of the wheel shown in FIG. 1 which is not visible when mounted on the vehicle and

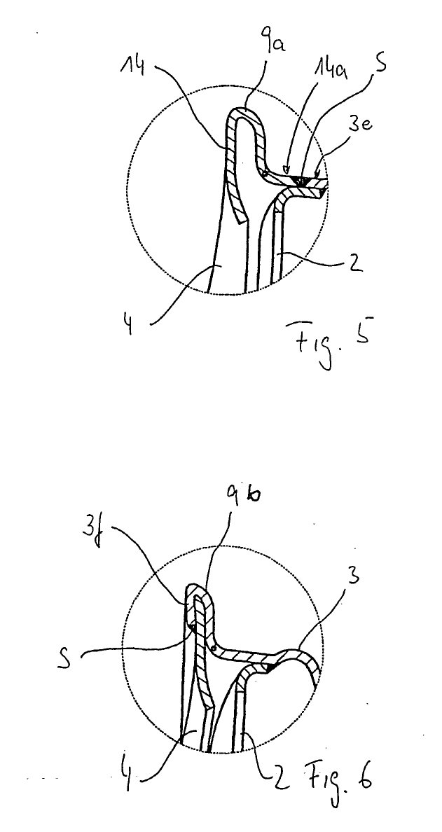

FIGS. 5-11 each shows a detail of a variant of the wheel shown in FIG. 1 in longitudinal section.

The wheel 1 shown in FIG. 1 is a spoke rim wheel made of pressed sheet steel elements. It is made up of a design shell 2, a rim ring 3 and a covering shell 4. The covering shell 4 which is visible to the outside when installed can be made of special steel in particular.

The design shell 2 has a centrally located hub opening 5 whose edge is seated on an assembly aide formed on the corresponding hub as the wheel 1 is mounted on the passenger car—PC for short—which is not shown. The hub opening 5 is surrounded by a ring-shaped screw-down flange 6 into which regularly distributed screw-down openings 7 are made at equal angular distances from each other. The edge zone of screw-down openings 7 extends conically, starting at the outside A of the wheel 1, so that a conical, self-centering seat is provided for the threaded bolts, not shown here, that are inserted into the respective screw-down openings 7 during assembly. Around the screw-down flange 6 and distributed in star shape at equal angular distances from each other, the design shell 2 is provided with radially extending spokes 8 the ends of which are in form of shackles and folded in the direction of the outside A and are welded to the inner surface 3i of the rim ring 3. Each spoke has a U-shaped cross-section which ensures great rigidity of form of the spokes 8.

The rim ring 3 is constituted in the manner of a “tailored blank” by three ring-shaped form elements 3a, 3b, 3c consisting of sheet steel materials with different strength and/or thicknesses which are welded flush to each other. In the embodiment shown in FIG. 1, the shape 3a is bent over in radial direction at its edge sections associated with the outside A, so that the outer rim flange 9 of the rim ring 3 is formed by the bent section. The rim ring 3 can of course consist of a ring-shaped element possessing different wall thickness caused by yield pressure or different strengths due to targeted strain hardening so-called flow-forming rims.

The covering shell 4 is installed from the outside A on the design shell 2. Its dimensions and form are such that the design shell 2 with its spokes 8 and its screw-down flange 6 as well as the rim ring 3 are covered on the outside A by corresponding form elements of the covering shell 4. Thus the covering shell 4 is also provided with a central opening 10, a ring 11 adapted to the form of the screw-down flange 6 of the design shell 2 around the central opening 10 with a passage opening 12 adapted to the position of the screw-down openings 7, with spoke covers 13 all around the ring 11 and with an outer ring 14 covering the rim ring 3 on the outside A.

The spoke covers 13 covering the spokes 8 of the design shell 2 have also U-shaped profile cross-sections, whereby their lateral sides 13a, 13b point in the direction of the inside I of wheel 1 across from the outside A. In this manner the spokes 8, which would otherwise be visible from the outside A, are covered in their lateral area. At the same time the U profile configuration of the spoke covers 13 ensures great stability of form of the covering shell 4.

In the embodiment shown in FIG. 1, the edge 14a going around the circumference of the outer ring 14 of the covering shell 4 is folded over the rim ring 3 formed on the outer rim flange 9 so that the rim ring 3 and the covering shell 4 are connected to each other in positive and non-positive manner in this area. At the same time the ring 11 of the covering shell 4 lies on the screw-down flange 6 of the design shell 2 and the border areas of the passage opening 12 of the covering shell 4 cover the border areas of the screw-down openings 7 of the design shell 2. In this manner the covering shell 4 and the design shell 2 are held together by the screw bolt that is screwed into one of the threaded bores on the hub of the PC to hold them and are held firmly in place on the hub during assembly of the wheel 1 on the PC which is not shown here. It is of course also possible to weld the covering shell 4 to the screw-down flange 6 of the design shell 2 in the area of the ring 11.

A ring element not shown here can be provided between the surface of the screw-down flange assigned to the inside I, and this ring element holds the wheel 1 at a fixed distance from the corresponding hub and prevents excessive heating up of the wheel by the heat produced as the vehicle is braked.

In the variant of the wheel 1 shown in FIG. 5, the ends of the spokes 8 of the design shell 2 assigned to the rim ring 3 are folded in the direction of the inside I and are welded to the inside surface 3i of the rim ring 3. The rim ring 3 does not have an outer border area formed into a rim flange but ends in the instead by the rim area of the outer ring 14 of the covering shell 4 which is bent several times. Bending is done in such manner in this case that its edge 14a meets flush with its assigned edge 3e of the rim ring 3. The rim ring 3 and the covering shell 4 are connected firmly and material-interlockingly together by a circulatory welding seam S in the area of their meeting edges 3e and 14a. Similarly, the material-interlocking connection can also be produced by welding that is limited to certain segments or points.

In the embodiment of wheel 1 as shown in FIG. 6, the border segment of the rim ring 3 constituting the rim flange 9b is folded around the outer edge 14 of the covering shell 4. The rim ring 3 and the covering shell 4 are also firmly and material-interlockingly connected to each other by a welding seam S on the circulatory wheel of the folded segment 3f.

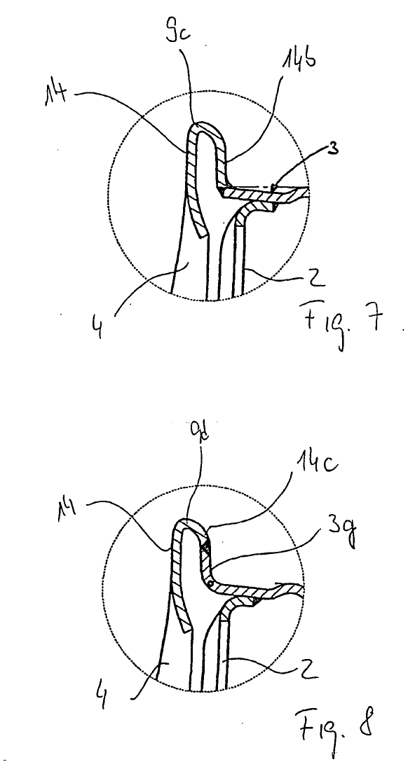

In the variant of wheel 1 shown in FIG. 7 the rim flange 9c is formed by a bending of the outer border area of the outer ring 14 of the covering shell 4 as in the variant of FIG. 5. By contrast with the variant shown in FIG. 5, the side 14b of the fold associated with the rim ring 3 extends only in radial direction while the rim ring 3 protrudes in the direction of the outside A beyond the end of the spokes 8 of the design shell 2. In this manner the sides 14b and the rim ring 3 meet in an edge zone in which they are firmly and material-interlockingly with each other by a welding seam.

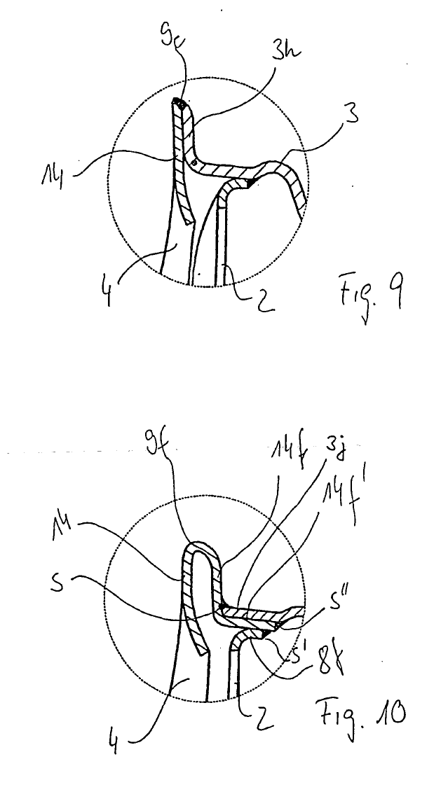

The variant shown in FIG. 8 is basically identical with the designs of the wheel 1 as shown in FIGS. 5 and 7. In this variant too, the rim flange 9d is formed by a folding of the outer ring 14 of the covering shell 4. In this case the folded side 14c of the outer ring associated with the rim ring 3 extends only over approximately one third of the height of the rim flange 9d. There it meets the edge of the outer border area 3g of the rim ring 3 which is folded in radial direction in this case, as in the example shown in FIG. 1. In the area where the edges of the outer ring 14 of the outer shell 4 and the folded border area 3g of the rim ring 3 meet, the rim ring 3 and the covering shell 4 are connected to each other by a welding seam.

In the example shown in FIG. 9 of an embodiment of wheel 1 the folded border area 3h of the rim ring 3 and the outer edge of the outer ring 14 which lies flat on the border area 3h meet at the circulatory free edge of the rim flange 9e and are there connected to each other by a circulatory welding seam.

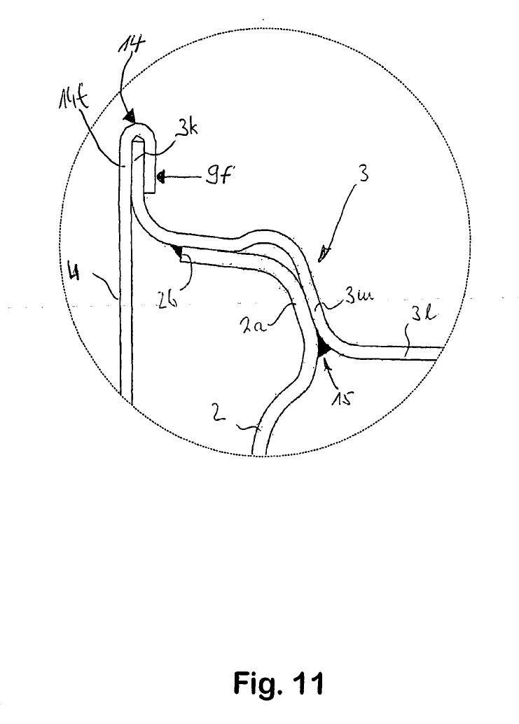

In the example of a variant of the wheel 1 shown in FIG. 10, the outer border area 14f of the outer ring 14 of the covering shell 4 is doubly folded as shown in the example of FIG. 5, so that its free border segment 14f′ pointing to the inside I is essentially parallel with the border area 3j of the rim flange 3 extending beyond the end of the spokes 8. This extended border area 3f lies in this case on the border segment 14f′ and reaches into the corner area where the border area 14f is bent over radially in the direction of the rim flange 9f. The rim ring 3 and the covering shell 4 are firmly connected to each other by a welding seam S made in this area. The ends 8f of the spokes 8 which are folded in the direction of the inside I rest in this case on the underside of the border area 14f′ away from the rim ring 3. The welding seams S′ also connect the border segment 14f′ and the ends of the spokes 8 firmly to each other. In addition, the free border of the folded border segment 14f is welded to the inside surface 3i of the rim ring by a welding seam S″.

In the example of a variant of wheel 1 shown in FIG. 11, the outer border area 14g of the outer ring 14 of the covering shell 4 is laid as coming from the outside around the circulatory border area 3k of the rim flange 9f of the rim ring 3so that the rim ring 3 and the covering shell 4 are connected to each other positively and non-positively. The design shell 2 is provided here with a border area 2a formed on its outer circumference that covers the rim ring 3 over a border area 3m starting from the bottom 31 of the rim ring 3 on the outside associated with the covering shell 4. In the area of the channel 15 constituted between the bottom 31 of the rim ring 3 as well as on the circumferential border 2b of the design shell, the rim ring 3 and the design shell 2 are welded together. In this manner the cantilevered length of the base shell 3 is limited to the smallest inside diameter of the rim ring 3, with the advantage that even when the wall thickness of design shell 2, rim ring 3 and covering shell 4 is minimized, an especially rigid wheel is obtained. On the other hand the double welding connection between rim ring 3 and design shell 2 ensures an especially strong connection between these two components.

Thanks to the material interlocking, positively and/or non-positively locking connection between the covering shell 4 and the rim ring 2 as well as between the design structure 2 and the covering shell 4 produced in the explained examples, the obtained result is that the design shell 2 and the covering shell 4 together absorb the force acting upon the rim ring 3. With suitable sizing and configuration it is possible to have the covering shell 4 absorbing up to one half of these forces. The covering shell 4 thus no longer serves only as a configuration element but participate substantially in the function of the wheel 1.

Reference Numbers

1 wheel
2 design shell
2a border area of the design shell 2
2b circumferential border 2b of the design shell 2
3 rim ring
3a, 3b, 3c form elements
3e border of the rim ring 3
3f folded segment
3g border area of the rim ring 3
3h border area of the rim ring 3
3i border area of the rim ring 3
3j border area of the rim ring 3
3k border area of the rim ring 3
3l bottom of the rim ring 3
3m border area of the rim ring 3
4 covering shell
5 hub opening
6 screw-on flange
6 screw-down openings
8 spokes
8f ends of the spokes 8
9 outer rim flange
9a rim flange
9b rim flange
9c rim flange
9d rim flange
9e rim flange
9f rim flange
10 central opening
11 ring
12 passage opening
13 spoke cover
13a, 3b lateral side of the spoke cover 13
14 outer ring
14 outer ring\
14a border
14a\ border segment of the outer ring 14
14f′ border segment
14f border area
15 channel
A outside of wheel 1
I inside of wheel 1
S′ welding seams
S welding seam
S″ welding seam

1. Wheel for motor vehicles, in particular passenger cars or motorcycles, built up in several parts, with a rim ring, with a design shell located in the opening surrounded by the rim ring and capable of being attached to a wheel hub of the motor vehicle concerned, and with a covering shell located on the outside of the wheel, whereby the design shell and the covering shell support the rim ring jointly and the force absorbed by the covering shell when the rim ring is under load is essentially equal to the force absorbed by the design shell.

2. Wheel as in claim 1, wherein
the covering shell is connected non-positively with the rim ring.

3. Wheel as in claim 1, wherein
the covering shell is connected positively with the rim ring.

4. Wheel as in claim 1, wherein
the covering shell is connected material-interlockingly with the rim ring, in particular by welding, soldering or bonding.

5. Wheel as in claim 1, wherein
the design shell is provided with screw-down openings through which the attachment to the corresponding hub of the motor vehicle is effected.

6. Wheel as in claim 5, wherein
the screw-down openings are formed in a screw-on flange of the design shell.

7. Wheel as in claim 5, wherein
the covering shell and the design shell can be screwed together to the corresponding hub of the motor vehicle by means of at least one screw connection.

8. Wheel as in claim 1, wherein
the covering shell is connected firmly to the design shell in the area of the screw-down openings.

9. Wheel as in claim 6, wherein
the design shell is provided with at least one spoke via which the rim ring is connected to the screw-on flange.

10. Wheel as in claim 1, wherein
the covering shell and the design shell are held at a distance from each other, at least in some sections.

11. Wheel as in claim 7, wherein
the spoke is made with a U-shaped profile at least in some sections.

12. Wheel as in claim 1, wherein
it is made of steel.

13. Wheel as in claim 1, wherein
the rim ring, the design shell and/or the covering shell are made of special steel.

14. Wheel as in claim 1, wherein
the rim ring is provided with a rim flange on its side associated with the covering shell.

15. Wheel as in claim 14, wherein
the covering shell is connected firmly by its border assigned to the rim ring at least in sections to the rim flange.

16. Wheel as in claim 15, wherein
the border of the covering shell assigned to the rim ring is bent around the rim flange and/or is material-interlockingly connected to the rim flange, being in particular welded, bonded or soldered.

17. Wheel as in claim 1, wherein
the rim flange is formed from a border section of the covering shell assigned to the rim ring.

18. Wheel as in claim 1, wherein
the rim ring is formed of several ring elements with different thicknesses and/or firmness.

19. Wheel as in claim 1, wherein
a ring element is located on the inside of the design shell away from the covering shell, said ring element holding the wheel at a distance from the corresponding hub of the motor vehicle in its mounted state on the motor vehicle.

20. Wheel as in claim 19, wherein
the ring element possesses low heat conductivity.

21. Wheel as in claim 19, wherein
the ring element attenuates sound.

22. Wheel as in claim 1, wherein
the covering shell is provided with a colored coating on its visible outside.

23. Wheel as in claim 1, wherein
the design shell covers a border area of the rim with a border area formed on its outer circumference and in that the design shell is material-interlockingly connected, in particular welded, to the rim ring in the area of the channel formed between the bottom of the rim ring as well as on the circumferential border of the design shell.

24. Wheel as in claim 1, wherein
it is intended to be mounted on a passenger car or truck and in that the covering shell is mounted on the outside of the wheel on its side away from the body of the motor vehicle when mounted.
